(19) United States
(12) Patent Application Publication
(10) Pub. No.: US 2018/0178923 A1
(43) Pub. Date: Jun. 28, 2018

(54) SEMI-CONTINUOUS FIXATION OF AN ENGINE ATTACHMENT PYLON TO AN ATTACHMENT DEVICE BELONGING TO THE WINGS OF AN AIRCRAFT

(71) Applicant: Airbus Operations SAS, Toulouse (FR)

(72) Inventors: Isabelle PETRISSANS-LLOVERAS, CUGNAUX (FR); Guillaume GALLANT, LAREOLE (FR); Olivier GLEIZE, TOULOUSE (FR); Olivier DUBOIS, CASTELGINEST (FR); Aurelien PANTEL, TOULOUSE (FR)

(21) Appl. No.: 15/849,243

(22) Filed: Dec. 20, 2017

(30) Foreign Application Priority Data
Dec. 23, 2016 (FR) 1663350

(51) Int. Cl. B64D 27/26; B64D 27/18; B64F 5/10

(52) U.S. Cl. CPC B64D 27/26; B64D 2027/264; B64F 5/10; B64D 27/18

(57) ABSTRACT

Fixation of an aircraft engine attachment pylon to the wing of an aircraft by means of an attachment device attached to a wing structure by means of first attachment through-members. The attachment device and the attachment pylon have respective junction surfaces clamped to each other by means of second attachment through-members. The junction surfaces extend along a plane forming an angle of less than 45 degrees with a vertical direction of the aircraft. A method for assembling the attachment pylon to the wing includes the positioning of the attachment pylon facing the attachment device, and then the clamping of the respective junction surfaces of the attachment device and of the attachment pylon to each other via the second attachment through-members.

### CROSS-REFERENCES TO RELATED APPLICATIONS

This application claims the benefit of the French patent application No. 1663350 filed on Dec. 23, 2016, the entire disclosures of which are incorporated herein by way of reference.

### TECHNICAL FIELD

The present invention relates to the field of aircraft, in particular airplanes, comprising at least one engine fixed to a wing. The invention relates more particularly to a novel method for attaching an engine, such as a jet engine, to a wing of an aircraft.

### BACKGROUND OF THE INVENTION

The isostatic attachment of an engine to the wing of an aircraft is generally performed by means of an attachment pylon linked to the wing by means of a few local attachments, commonly called “wing attachments.”

These attachments typically comprise end fittings formed on the attachment pylon, and other end fittings formed in one or more attachment devices generally comprising braces, fixed to a wing structure by means of attachment through-members such as bolts. The end fittings of the attachment pylon and the end fittings of the attachment devices are linked to one another directly by means of shafts, or indirectly via connecting rods.

In the case of an engine fixed hyperstatically to the wing of an aircraft, the link between the attachment pylon and the wing is also made by means of a few local attachments.

In both cases, the loads passing from the engine to the wing are concentrated in these few attachments (end fittings, shafts and/or connecting rods), which therefore have to be particularly solid and bulky.

Attachments of this type therefore increase the overall weight of the aircraft. In addition, the bulk of such attachments results in an increase in the master cross section and the wetted surface of the attachment pylon, and therefore generally causes the aerodynamic performance levels of the aircraft to be reduced.

### SUMMARY OF THE INVENTION

The aim of the invention is notably to provide a solution to this problem which is simple, economical and efficient, which does not substantially increase the complexity of the manufacturing and maintenance operations relating to the means for attaching an engine to the wing of an aircraft.

To this end, the invention proposes an aircraft comprising wings, and at least one engine supported by an attachment pylon comprising a respective box-form structure linked to at least one wing by means of an attachment device comprising a respective box-form structure comprising a surface by which the attachment device is fastened to a wing structure by means of first attachment through-members.

The respective structures of the attachment device and of the attachment pylon have respective junction surfaces clamped together by means of second attachment through-members, the junction surfaces extending in a plane forming an angle less than 45 degrees with a vertical direction of the aircraft or forming an angle greater than 45 degrees with an elastic line of the respective structure of the attachment pylon.

The attachment device and the attachment pylon are thus linked in a distributed manner, also called “semi-continuous” manner, by means of the second attachment through-members clamping together the respective junction surfaces of the respective structures of the attachment device and of the attachment pylon. Such a linking mode is, of course, hyperstatic.

The second attachment members are mainly traction-loaded (because of overall flexural deformations of the structure of the attachment pylon), and to a lesser extent, shear-loaded.

The second attachment through-members typically number several tens, for example between thirty and forty.

Generally, the novel method for linking the attachment pylon to the wing proposed by the invention allows for a reduction of the overall weight of the aircraft, as well as a reduction of the master cross section and of the wetted surface of the attachment pylon.

Furthermore, the dismantling of the attachment pylon can be done simply by dismantling the second attachment through-members.

In preferred embodiments of the invention, the second attachment through-members pass jointly through passage orifices formed respectively in the respective junction surfaces of the respective structures of the attachment device and of the attachment pylon.

These second attachment through-members are preferably bolts.

In a manner known per se, the first attachment through-members are also preferably bolts.

In preferred embodiments of the invention, the respective junction surfaces of the respective structures of the attachment device and of the attachment pylon each have a closed loop form comprising a top rectilinear portion, a bottom rectilinear portion, and two opposing lateral rectilinear portions.

In preferred embodiments of the invention, the aircraft comprises a junction rib interposed between the respective junction surfaces of the respective structures of the attachment device and of the attachment pylon.

In preferred embodiments of the invention, the first attachment through-members link a rear part of the surface of the respective structure of the attachment device, by which this structure is fastened to the wing, to a skin of the wing.

In preferred embodiments of the invention, the surface of the respective structure of the attachment device, by which this structure is fastened to the wing, comprises a front part linked to a web of a front spar of the wing.

In preferred embodiments of the invention, the respective junction surfaces of the respective structures of the attachment device and of the attachment pylon extend parallel to the vertical direction.

In preferred embodiments of the invention, the respective junction surfaces of the respective structures of the attachment device and of the attachment pylon extend orthogonally to the elastic line of the attachment pylon.

In preferred embodiments of the invention, at least a rear part of the respective structure of the attachment device has a cross section whose area decreases from front to rear.

Preferably, the structure of the attachment device comprises at least one aperture and delimits an internal space in which the aperture emerges and in which at least one extinguisher is housed.

In preferred embodiments of the invention, the respective structure of the attachment device comprises a bottom surface, two opposing lateral surfaces, and a top surface which forms the surface by which the attachment device is fastened to the wing structure by means of the first attachment through-members.

The invention relates also to a method for assembling an attachment pylon with the wing of an aircraft comprising an attachment device comprising a respective box-form structure comprising a surface by which the attachment device is fastened to a wing structure by means of first attachment through-members, the method comprising the positioning of a respective structure of the attachment pylon facing a respective structure of the attachment device, then the clamping of respective junction surfaces of the respective structures of the attachment device and of the attachment pylon to one another by means of second attachment through-members, such that the junction surfaces extend in a plane forming an angle less than 45 degrees with a vertical direction of the aircraft or forming an angle greater than 45 degrees with an elastic line of the respective structure of the attachment pylon.

### BRIEF DESCRIPTION OF THE DRAWINGS

The invention will be better understood, and other details, advantages and features thereof will become apparent on reading the following description given as a nonlimiting example and with reference to the attached drawings in which:

FIG. 1 is a schematic side view of an aircraft according to a preferred embodiment of the invention;

FIG. 2 is a schematic side view, on a larger scale, of the wing, of an attachment device and of an attachment pylon belonging to the aircraft of FIG. 1;

FIG. 3 is a schematic perspective view of the attachment device and of the attachment pylon, represented alone and separate from one another;

FIG. 4 is a schematic cross-sectional view of the attachment device and of the attachment pylon, in the transverse plane A-A of FIG. 2;

FIG. 5 is a schematic cross-sectional view of the attachment device and of the attachment pylon, in the longitudinal vertical plane B-B of FIG. 4, forming a median plane of respective junction surfaces of the attachment device and of the attachment pylon;

FIG. 6 is a schematic cross-sectional view of the attachment device and of the attachment pylon, in the longitudinal plane C-C of FIG. 4, parallel to a lateral rectilinear portion of the respective junction surfaces of the attachment device and of the attachment pylon;

FIG. 7 is a schematic cross-sectional view of the attachment device and of the attachment pylon, in the longitudinal plane D-D of FIG. 4, parallel to a top rectilinear portion of the respective junction surfaces of the attachment device and of the attachment pylon;

FIG. 8 is a view similar to FIG. 4, illustrating a variant embodiment of the aircraft;

FIG. 9 is a partial schematic perspective view of the aircraft of FIG. 1, illustrating a method for assembling the attachment pylon with the wing of the aircraft;

FIG. 10 is a partial schematic perspective view of an aircraft according to another preferred embodiment of the invention;

FIG. 11 is a schematic perspective view on a larger scale of an attachment device belonging to an aircraft according to another preferred embodiment of the invention.

In all these figures, identical references can denote identical or similar elements.

### DETAILED DESCRIPTION OF THE PREFERRED EMBODIMENTS

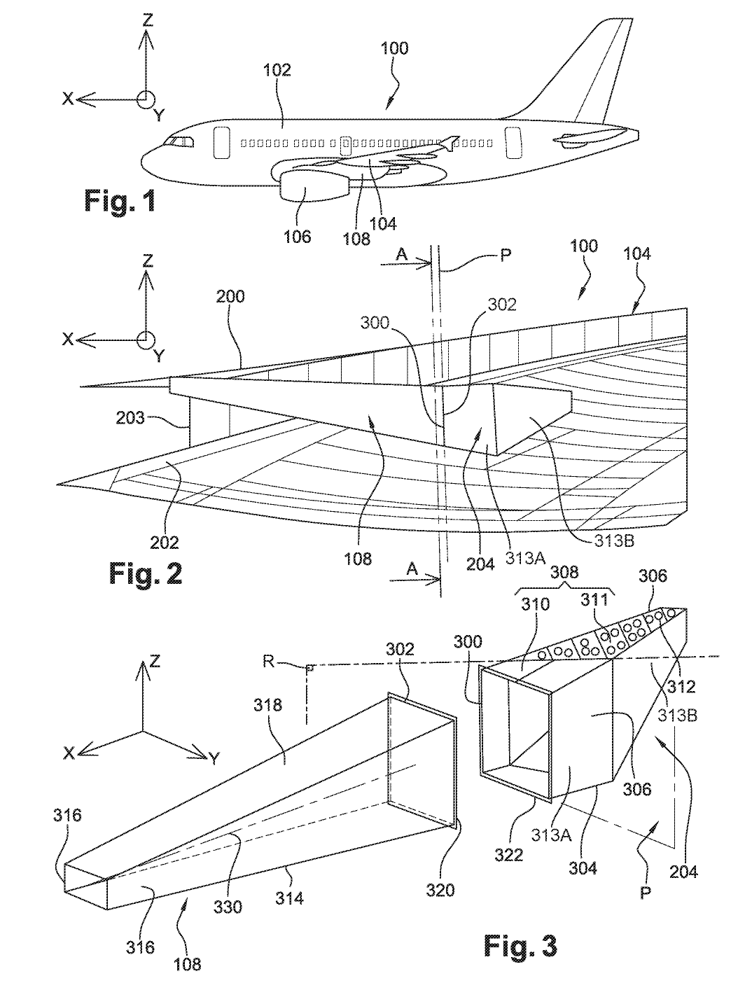

FIG. 1 generally illustrates an aircraft 100, in this case an airplane, comprising a fuselage 102, a wing 104, and engines 106, in this case jet engines, mounted under the wing 104 by means of respective attachment pylons 108 (one of the engines being hidden in the figure). Although only one side of the aircraft is shown, typically, the opposite side is symmetrical with the side that is shown.

In the following description, X denotes the longitudinal or axial direction of the aircraft corresponding to a direction of advancement of the aircraft or even to the direction of its roll axis, Z denotes the vertical direction, defined thus when the aircraft is parked on a horizontal surface, and corresponding generally to the direction of the yaw axis of the aircraft, and Y denotes the transverse direction, orthogonal to the preceding two directions and corresponding generally to the direction of the pitch axis of the aircraft. The directions X and Y define so-called “horizontal” planes with reference to the orientation of the aircraft when the latter is parked on the ground.

FIG. 2 shows a part of one of the wings 104 of the aircraft, more particularly a top skin 200, a bottom skin 202, and the web 203 of a front spar belonging to the wing structure, and the attachment pylon 108 of one of the engines, and an attachment device 204 linking the attachment pylon 108 to the wing 104.

As FIG. 3 shows, the attachment device 204 and the attachment pylon 108 have respective junction surfaces 300, 302 extending in a plane P, which, in this example, is a plane parallel to the vertical direction Z of the aircraft. These two junction surfaces 300, 302 have forms similar to one another.

The attachment device 204 is formed by a respective box-form structure having a cross section of rectangular form varying in the longitudinal direction X, and comprising a bottom surface 304, two opposing lateral surfaces 306, and a top surface 308 comprising a front part 310 (FIG. 3), and rear part 311 fastened to the wing 104 (FIG. 2), for example to the bottom skin 202, by means of first attachment through-members 312 (FIG. 3), which are, for example, tension bolts.

The structure of the attachment device 204 generally comprises a front part 313A, comprising the front part 310 of the top surface 308, and having a transverse extent which decreases from front to rear and a vertical extent which increases from front to rear. The structure of the attachment device 204 further comprises a rear part 313B, comprising the rear part 311 of the top surface 308, and having a cross section whose area decreases from front to rear (FIGS. 2 and 3). In the example illustrated, the extents of the rear part 313B respectively in the transverse direction Y and in the vertical direction Z decrease from front to rear. Furthermore, the junction between the front part 313A and the rear part 313B extends in a plane R that is inclined in relation to the plane P of the junction surface 300 (FIG. 3). The plane R extends substantially parallel to the web 203 of the front spar.

The attachment pylon 108 also comprises a respective box-form structure, having a bottom surface 314 (FIG. 3), two opposing lateral surfaces 316, and a top surface 318.

In the example illustrated, the structure of the attachment pylon 108 has a rectangular cross section whose area increases from front to rear (FIGS. 2 and 3).

The junction surface 302 of the attachment pylon 108 is a rear face of an end flange 320 of the structure of the attachment pylon 108 (FIG. 3). Likewise, the junction surface 300 of the attachment device 204 is a front face of an end flange 322 forming a front end of the front part 310 of the structure of the attachment device 204.

In the example illustrated, the end flanges 320 and 322 extend by protruding outward from the corresponding box-form structures.

As a variant, these end flanges 320 and 322 can extend by protruding toward the interior of the corresponding structures.

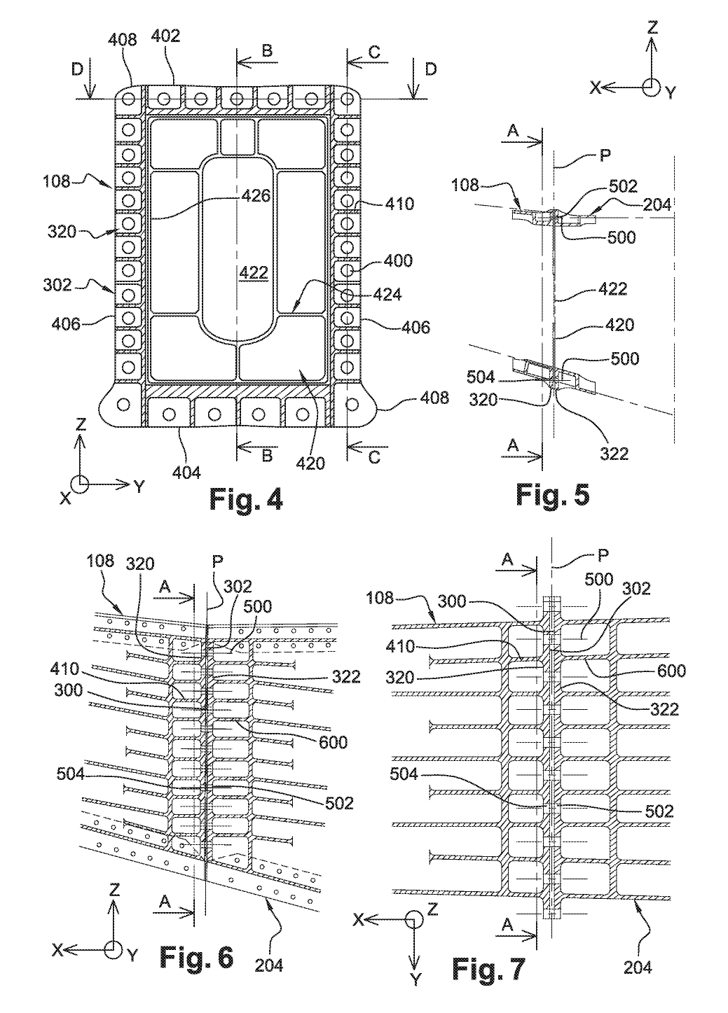

As FIGS. 4-7 show, the respective junction surfaces 300, 302 of the respective structures of the attachment device 204 and of the attachment pylon 108 are clamped to one another by means of second attachment through-members 400, visible only in FIG. 4, the axes 500 of these second attachment through-members 400 being visible in FIGS. 5-7.

The second attachment through-members 400 pass jointly through the respective junction surfaces 300, 302 of the respective structures of the attachment device 204 and of the attachment pylon 108. These second attachment through-members 400 are for example bolts.

As a variant, the second attachment through-members 400 can be incorporated in one of the junction surfaces 300, 302 and pass through the other of these junction surfaces 300, 302.

FIG. 4 shows a front face of the end flange 320 of the structure of the attachment pylon 108, that is to say the face situated on the side opposite the junction surface 300 of the structure of the attachment device 204. In this figure, the junction surface 300 of the structure of the attachment device 204 is thus concealed by the end flange 320.

As FIG. 4 shows, each of the junction surfaces 300, 302 is generally of polygonal closed loop form, for example rectangular. Each junction surface 300, 302 comprises, in particular, a top rectilinear portion 402, a bottom rectilinear portion 404, and two opposing lateral rectilinear portions 406. Rounded vertices 408 of the polygonal closed loop connect each of the top 402 and bottom 404 rectilinear portions to the lateral rectilinear portions 406.

Each of the rectilinear portions 402, 404, 406 of each of the junction surfaces 300, 302 is provided with a plurality of passage orifices 502, 504 (FIGS. 5 to 7) to allow the passage of the second attachment through-members 400.

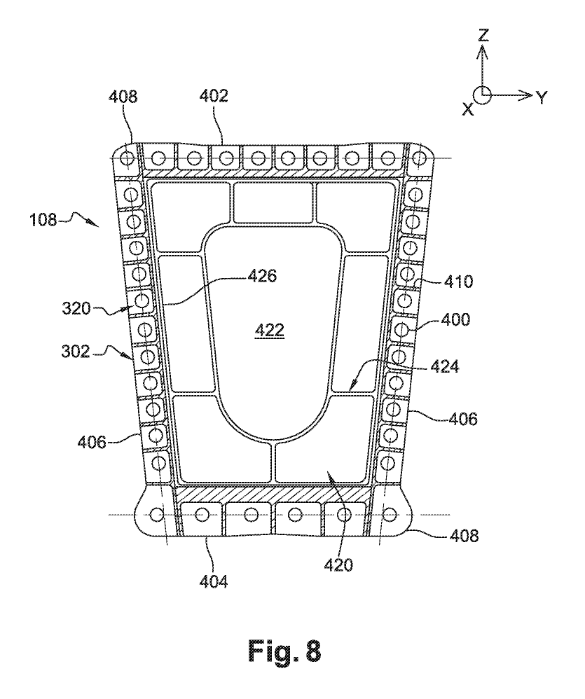

As a variant, other polygonal closed loop forms are possible with regard to the junction surfaces 300, 302 without departing from the scope of the invention. For example, a trapezoidal closed loop form as illustrated in FIG. 8.

Referring to FIGS. 4, 6 and 7, the end flange 320 of the structure of the attachment pylon 108 comprises, on its face opposite the face forming the junction surface 302, that is to say, on its front face, ribs 410 arranged alternately with the passage orifices 504 of the second attachment through-members 400, such that the ribs 410 delimit compartments or cells for these members 400 between them.

Likewise, referring to FIGS. 6 and 7, the end flange 322 of the structure of the attachment device 204 comprises, on its face opposite the face forming the junction surface 300, that is to say, on its rear face, ribs 600 arranged alternately with the passage orifices 502 of the second attachment through-members 400, such that the ribs 600 delimit compartments or cells for these members 400 between them.

Preferably, a junction rib 420 (FIG. 4) is interposed between the respective junction surfaces 300, 302 of the respective structures of the attachment device 204 and of the attachment pylon 108.

The junction rib 420 comprises a median aperture 422 surrounded by a network of stiffening ribs 424 which is itself surrounded by a closure rib 426 having substantially the form of the internal section of the structure of the attachment pylon 108 at the junction surface 302 thereof, but nevertheless preferably being separated by a small gap from the structure of the attachment pylon 108. The junction rib 420 further comprises a peripheral edge interposed between the junction surfaces 300, 302 (this peripheral edge being concealed in the figures). This peripheral edge is, of course, also provided with passage orifices for the second attachment through-members 400.

Like the braces of the aircraft of known type, the attachment device 204 is fastened to the wing during the wing assembly phase, that is to say, prior to the assembly of the attachment pylon 108 with the attachment device 204.

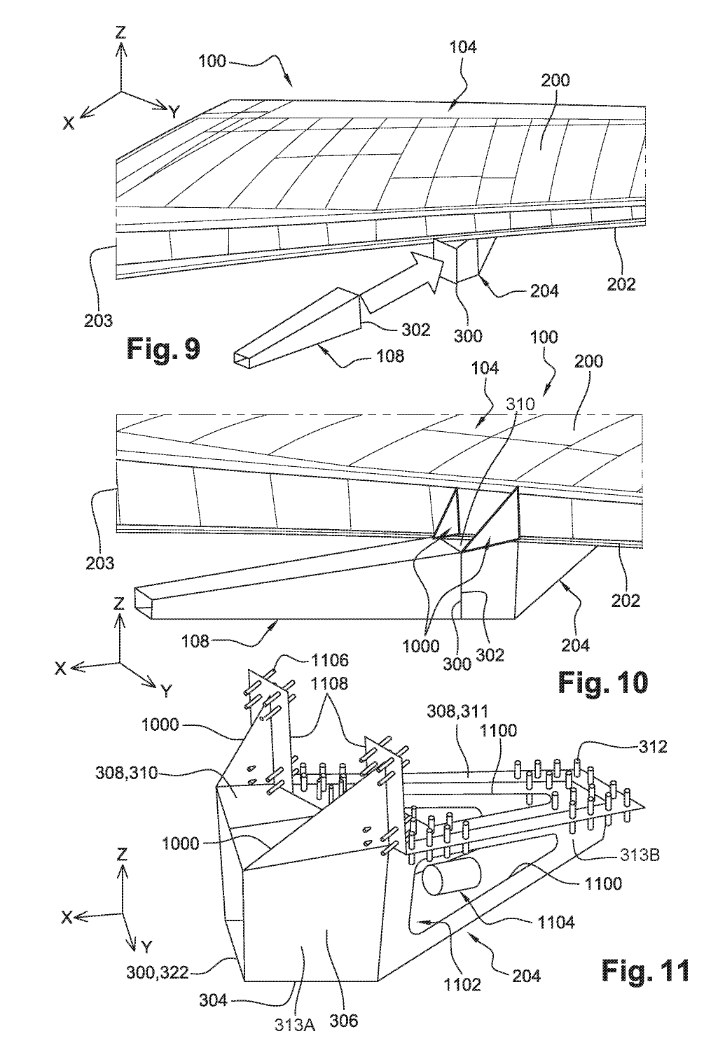

FIG. 9 illustrates a method for assembling the attachment pylon 108 with the wing 104. This method comprises the positioning of the structure of the attachment pylon 108 facing the structure of the attachment device 204, then the clamping of the respective junction surfaces 300, 302 of the respective structures of the attachment device 204 and of the attachment pylon 108 to one another by means of the second attachment through-members 400.

In the preferred embodiment of the invention, the method comprises the positioning of the junction rib 420 between the junction surfaces 300 and 302.

In the example described above, the plane P is a vertical plane.

As a variant, this plane can nevertheless exhibit an inclination in relation to the vertical direction Z. To allow a good transmission of loads by the second attachment through-members 400, it is nevertheless preferable for the plane P to form an angle less than 45 degrees with the vertical direction Z of the aircraft.

Another criterion, alternative or complementary, making it possible to guarantee optimal effectiveness of the second attachment through-members 400, is for the plane P to form an angle greater than 45 degrees with the elastic line 330 of the structure of the attachment pylon 108 (FIG. 3), that is to say, the neutral fiber (also called median line) of the structure of the attachment pylon, when the latter is deformed by the static loads induced by the engine 106. As the person skilled in the art knows, the elastic line 330 of the structure of the attachment pylon 108 corresponds to the line passing through the centers of gravity of the straight sections of this structure.

In this regard, in preferred embodiments of the invention (not illustrated), the plane P is substantially orthogonal to the elastic line 330.

In practice, the elastic line 330 extends generally in a direction close to the horizontal, such that the abovementioned two criteria are largely equivalent to one another.

In another embodiment of the invention illustrated in FIG. 10, the front part 310 of the top surface 308 of the attachment device 204 is linked to the web 203 of the front spar of the wing 104, for example by means of two lateral fins 1000 of generally triangular form which upwardly prolong the two lateral surfaces 306 of the structure of the attachment device 204.

The linking of the front part 310 of the top surface 308 to the web 203 can, as a variant, be produced by means of linking rods.

The front part 310 of the top surface 308 extends by protruding forward in relation to the front spar of the wing 104, to allow the top surface 308 to be linked to the web 203 of the front spar of the wing.

Generally, the linking of the front part 310 of the top surface 308 of the structure of the attachment device 204 to the web 203 of the front spar of the wing 104 makes it possible to reduce the overhang of the attachment pylon 108, and therefore to reduce the flexural moment of the attachment pylon.

FIG. 11 illustrates the attachment device 204 of an aircraft according to yet another embodiment of the invention, similar to the embodiment of FIG. 10 except in that the lateral surfaces 306, and the rear part 311 of the top surface 308, each have an aperture 1100 allowing access to an internal space 1102 delimited by the structure of the attachment device 204. This internal space 1102 is, for example, exploited to house one or more extinguishers 1104. In the prior art, such extinguishers are housed behind the structural elements constituting the attachment pylon and the attachment device or devices, and therefore occupy an additional space.

FIG. 11 also illustrates a preferential method for fastening lateral fins 1000 to the web 203 of the front spar of the wing 104, by means of third attachment through-members 1106, such as bolts, fastening respective flanges 1108 of the lateral fins 1000 to the web 203 of the front spar.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
wings,
at least one engine,
an attachment pylon supporting the engine and comprising a respective box-form structure,
an attachment device linking the attachment pylon to one of the wings comprising a respective box-form structure comprising a surface by which the attachment device is fastened to a wing structure by means of first attachment through-members,
wherein the respective structures of the attachment device and the attachment pylon have respective junction surfaces clamped together by means of second attachment through-members, the junction surfaces extending in a plane forming an angle less than 45 degrees with a vertical direction of the aircraft or forming an angle greater than 45 degrees with an elastic line of the respective structure of the attachment pylon.

2. The aircraft as claimed in claim 1, in which the second attachment through-members pass jointly through passage orifices formed respectively in the respective junction surfaces of the respective structures of the attachment device and the attachment pylon.

3. The aircraft as claimed in claim 1, in which the respective junction surfaces of the respective structures of the attachment device and of the attachment pylon each have a closed loop form comprising a top rectilinear portion, a bottom rectilinear portion, and two opposing lateral rectilinear portions.

4. The aircraft as claimed in claim 1, comprising a junction rib interposed between the respective junction surfaces of the respective structures of the attachment device and of the attachment pylon.

5. The aircraft as claimed in claim 1, wherein the first attachment through-members link a rear part of said surface of the respective structure of the attachment device to a skin of the wing, and said surface of the respective structure of the attachment device comprises a front part linked to a web of a front spar of the wing.

6. The aircraft as claimed in claim 1, wherein the respective junction surfaces of the respective structures of the attachment device and of the attachment pylon extend parallel to the vertical direction.

7. The aircraft as claimed in claim 1, in which the respective junction surfaces of the respective structures of the attachment device and of the attachment pylon extend orthogonally to the elastic line of the respective structure of the attachment pylon.

8. The aircraft as claimed in claim 1, in which at least a rear part of the respective structure of the attachment device has a cross section whose area decreases from front to rear.

9. The aircraft as claimed in claim 8, in which the respective structure of the attachment device comprises at least one aperture and delimits an internal space in which the aperture emerges and in which at least one extinguisher is housed.

10. The aircraft as claimed in claim 1, in which the respective structure of the attachment device comprises a bottom surface, two opposing lateral surfaces, and a top surface which forms said surface by which the attachment device is fastened to the wing structure by means of the first attachment through-members.

11. A method for assembling an attachment pylon with the wing of an aircraft comprising an attachment device comprising a respective box-form structure comprising a surface by which the attachment device is fastened to a wing structure by means of first attachment through-members, the method comprising:
positioning of a respective structure of the attachment pylon facing the respective structure of the attachment device, and
clamping of respective junction surfaces of the respective structures of the attachment device and of the attachment pylon to one another by means of second attachment through-members, such that the junction surfaces extend in a plane forming an angle less than 45 degrees with a vertical direction of the aircraft or forming an angle greater than 45 degrees with an elastic line of the respective structure of the attachment pylon.
